(19) United States
(12) Patent Application Publication
(10) Pub. No.: US 2019/0137959 A1
(43) Pub. Date: May 9, 2019

(54) OPERATION REPLAY MODULE USING HISTORY STORAGE

(71) Applicant: Jong Tae KIM, Gyeonggi-do (KR)

(72) Inventor: Jong Tae KIM, Gyeonggi-do (KR)

(21) Appl. No.: 16/097,359

(22) PCT Filed: Mar. 23, 2017
(86) PCT No.: PCT/KR2017/003109

§ 371 Date: Oct. 29, 2018

(30) Foreign Application Priority Data
Apr. 29, 2016 (KR) 10-2016-0053064

(51) Int. Cl. G05B 15/02; A63H 33/26

(52) U.S. Cl. CPC G05B 15/02; A63H 33/26

(57) ABSTRACT

An operation replay module comprises: a manipulation command input unit that receives a manipulation command from a user; an output unit that outputs a control signal corresponding to the manipulation command from the manipulation command input unit; a memory that stores history of the manipulation command; a replay command input unit that receives a replay command from the user; and a micom that outputs a control signal corresponding to the history of the manipulation command stored in the memory to the output unit, if the micom receives the replay command from the replay command input unit.

### BACKGROUND

The present invention relates to an operation replay module, and, more particularly, to a technique capable of repeating the same operation when a replay command is inputted, after a manipulation command or circumstance change is measured and stored by a sensor when a specific device or system is operated.

Devices and systems, for example, illuminating devices, audio devices, air conditioning systems, mobile toys, robots, etc., usually perform a specific operation corresponding to a programmed command or a manipulation command inputted by a user.

However, in case where the device or system is operated by the programmed command, the device or system is not applied by the user's will. Accordingly, it is not possible for any user with no knowledge of a program to set the operation.

To this end, a technique is disclosed in Korean Patent No. 10-0352028 (Aug. 27, 2002), entitled “Toy device capable of downloading data”, wherein the toy device can download control information stored in a computer to execute various operations. There is a problem of being always connected to a computer to set the operation.

A device which is operated by a manipulation command from a user is inconvenient to input the manipulation command whenever the same operation is executed. Furthermore, it is not possible to again execute the same operation if the user forgets the manipulation command executed previously.

### SUMMARY OF THE INVENTION

Therefore, the present invention has been made in view of the above problems, and an object of the present invention is to provide an operation replay module using history storage that can store a manipulation command or a value measured by a sensor when various devices or systems are operated, and can replay the same operation corresponding to the manipulation command or the value measured by the sensor, if a replay command is inputted.

In order to achieve the above object, according to one aspect of the present invention, there is provided an operation replay module including: a manipulation command input unit that receives a manipulation command from a user; an output unit that outputs a control signal corresponding to the manipulation command from the manipulation command input unit; a memory that stores history of the manipulation command; a replay command input unit that receives a replay command from the user; and a micom that outputs a control signal corresponding to the history of the manipulation command stored in the memory to the output unit, if the micom receives the replay command from the replay command input unit.

According to another aspect of the present invention, there is provided an operation replay module including: a sensor unit that measures a physical value generated by physical operation to output sensing information; a converter that converts history of the sensing information into a control signal; a memory that stores the control signal converted by the converter; a replay command input unit that receives a replay command from the user; and a micom that outputs a control signal corresponding to history of the sensing information stored in the memory to an output unit, if the micom receives the replay command from the replay command input unit.

The operation replay module further includes a manipulation command input unit that receives a manipulation command from the user, and an output unit that outputs a control signal corresponding to the manipulation command from the manipulation command input unit, wherein the sensor unit measures a physical value of a device which is operated by the control signal outputted from the output unit to output sensing information.\

A range of set values is previously stored in the memory, and if the micom determines that the sensing information measured by the sensor unit reaches within the range of the set values stored in the memory, the micom stores the control signal related to the history of the sensing information in the memory.

The operation replay module further includes a storage command input unit that receives a storage command from the user, wherein if the micom receives the storage command from the storage command input unit, the micom stores the history of the manipulation command or the control signal related to the history of the sensing information in the memory.

As described above, even though the user has no specialized knowledge of programing, the user can replay the same operation on the device or system, without re-inputting the manipulation command, if the user intentionally manipulates the device or system and inputs the replay command. Therefore, the present invention can improve user convenience in the field of toy robot or office automation.

The present invention can be applied to the fields of industrial robot, domestic robot, home automation and building automation, in addition to an illuminating device, an audio device, an air conditioning system, and a toy robot.

### BRIEF DESCRIPTION OF THE DRAWINGS

FIG. 1 is a block diagram illustrating an operation replay module according to one embodiment of the present invention.

FIGS. 2 to 5 are flowcharts illustrating a procedure of the operation replay module in FIG. 1.

### DETAILED DESCRIPTION OF THE PREFERRED EMBODIMENT

Hereinafter, an embodiment of the present invention will be explained in detail in conjunction with the accompanying drawings. In the following description, detailed descriptions of well-known functions or constructions will be omitted since they would obscure the invention in unnecessary detail. Numerous alternative embodiments may be devised by those skilled in the art without departing from the scope of the following claims.

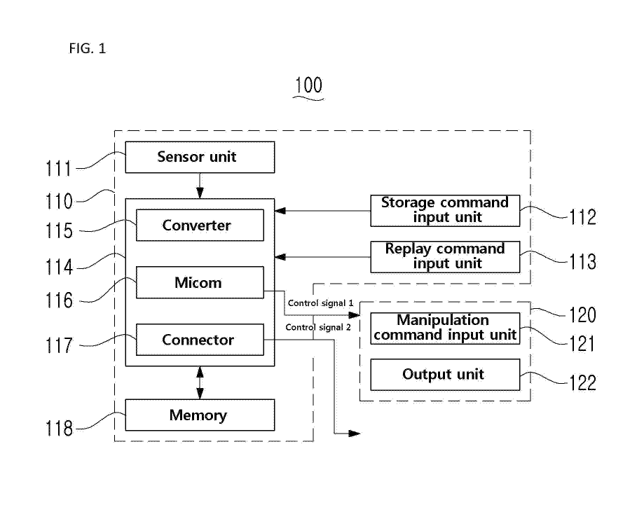

FIG. 1 is a block diagram illustrating an operation replay module using history storage according to one embodiment of the present invention. As illustrated in FIG. 1, an operation replay module 100 according to one embodiment of the present invention generally includes a storage module 110 and a replay module 120.

The storage module 110 is a module capable of storing history of manipulation commands inputted through the replay module 120, or a physical value measured by recognizing the physical operation of a device or system operated by the replay module 120, i.e., sensing information, and then, if a replay command is inputted, outputting a control signal corresponding to the history of the sensing information stored therein.

The replay module 120 is configured to cause the device or system to carry out a specific operation according to the input of the manipulation command from the user, or cause the device or system to carry out a specific operation according to the control signal outputted from the storage module 110.

The storage module 110 and the replay module 120 may be mounted together in one device or system, or may be separately provided and disposed at a proper position.

The storage module 110 includes a sensor unit 111, a storage command input unit 112, a replay command input unit 113, a control unit 114 and a memory 118.

If the device performs a specific operation according to a control signal outputted from an output unit 122 of the replay module 120 or an external force, the sensor unit 111 measures physical information, i.e., a physical value, according to the operation, and outputs sensing information related to the physical value.

For example, in case where the output unit 122 of the replay module 120 causes an illuminating device to perform operation, the sensor unit 111 may be an optical sensor, and thus the sensor unit 111 may measure intensity of illumination according to a variation in intensity of illumination of the illuminating device to output the sensing information related to the measured intensity of illumination.

Alternatively, in case where the output unit 122 of the replay module 120 causes a loudspeaker of an audio device to perform operation, the sensor unit 111 may be a sound pressure sensor, and thus the sensor unit 111 may measure sound pressure according to a variation in volume outputted from a loudspeaker to output the sensing information related to the measured sound pressure.

Further alternatively, in case where the output unit 122 of the replay module 120 causes an air conditioning system to operate, the sensor unit 111 may be a temperature sensor, and thus the sensor unit 111 measures a temperature to be changed according to heating or cooling to output the sensing information related to the measured temperature.

Further alternatively, in case where the output unit 122 of the replay module 120 is an encoder sensor, and thus the sensor unit 111 measures an encoder signal to be changed according to joint motion of a robot to output the sensing information related to the measured encoder signal.

The storage command input unit 112 is configured to input a storage command. In other words, a switch or a button is provided so that a user can input the storage command at the time of starting storage.

The replay command input unit 113 is configured to input a replay command. In other words, a switch or a button is provided so that a user can input the replay command at the time of starting the stored command.

The control unit 114 controls the whole processes for the storage and the replay if a command is inputted by the storage command input unit 112 or the replay command input unit 113. The control unit 114 includes a converter 115, a micom 116 and a connector 117.

The converter 115 is configured to convert the sensing information (physical value) measured by the sensor unit 111 into a control signal. The sensing information measured and outputted from the sensor unit 111 may be analog information, such as a voltage value or a resistance value. The sensing information cannot be used as a signal to control a specific operation later. To this end, the converter 115 converts the sensing information which is analog information, such as a voltage value or a resistance value, into a digital signal, such as a pulse value.

The manipulation command input unit 121 of the replay module 120 outputs the control signal, such as a pulse value, to carry out the operation corresponding to the manipulation command inputted by the user. Accordingly, even though the manipulation command inputted from the manipulation command input unit 121 is stored without any transformation, the manipulation command can be used to replay the same operation.

The micom 116 stores the history of the sensing information measured by the sensor unit 111 in the memory 118, if the storage command is inputted from the storage command input unit 112. More specifically, if the sensing information outputted from the sensor unit 111 is converted into the control signal by the converter 115, the micom 116 stores the converted control signal in the memory 118.

Also, if the storage command is inputted from the storage command input unit 112, the micom 116 may store the history of the manipulation command of the user inputted from the manipulation command input unit 121 of the replay module 120 in the memory 118.

Further, the micom 116 may not operate according to the storage command inputted from the storage command input unit 112, but after the micom determines whether the sensing information measured by the sensor unit 111 reaches within a range of a set value which has been stored in the memory 118 in advance, the micom may stores the history of the manipulation command or the history of the sensing information in the memory 118.

Also, if the replay command is inputted from the relay command input unit 113, the micom 116 outputs the control signal corresponding to the history of the manipulation command or the history of the sensing information stored in the memory 118.

The connector 117 is configured to transmit the control signal outputted from the micom 116 to an external appliance.

The memory 118 is configured to store the history of the manipulation command inputted from the manipulation command input unit 121 or the control signal corresponding to the history of the sensing information which is measured by the sensor unit 111 and converted by the converter 115. Also, the memory 118 may store the range of the set value which is used as a reference of storage start or storage end of the history of the manipulation command or the history of the sensing information.

The replay module 120 performs a specific operation according to the manipulation command inputted by the user or the control signal outputted from the micom 116. The replay module 120 includes the manipulation command input unit 121 and the output unit 122.

The manipulation command input unit 121 is configured to receive the manipulation command inputted by the user. The manipulation command inputted from the manipulation command input unit 121 is directly outputted as the control signal which is transmitted to the output unit 122.

The output unit 122 is configured to perform a special operation according to the manipulation command inputted from the manipulation input unit 121 or the control signal outputted from the micom 116.

For example, the output unit 122 of the replay module 120 can change the intensity of illumination of the illuminating device, change the volume of the loudspeaker of the audio device, adjust the temperature of the air conditioning system, or revolution or direction of a drive motor of a toy robot according to the control signal related to the manipulation command or the control signal outputted from the micom 116.

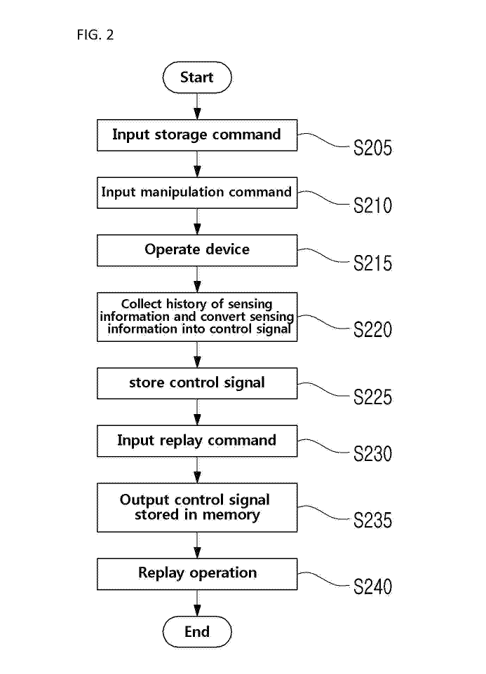

The procedure of the operation replay module 100 described above will be explained with reference to FIGS. 2 to 4.

First, FIG. 2 shows the process of storing and replaying the history of the sensing information, if the storage command of the user is inputted by the operation replay module in FIG. 1.

First, the user inputs the storage command by the storage command input unit 112 to store the process to be replay later (S205). That is, it signals the start of the storage.

Then, if the user inputs the manipulation command by the manipulation command input unit 121 (S210), the output unit 122 of the replay module 120 operates the device or system according to the manipulation command (S215).

For example, the output unit 122 of the replay module 120 can sequentially control the intensity of illumination of the illuminating device in a mode of 3-5-12-7-1-0, the volume of the audio device in a mode of 30-25-20-15-5-0, the temperature of an air conditioner in a mode of 18-20-24-26 degrees, or the toy robot in a process of forwarding 10 cm, left turning, reversing 20 cm, turning a head in a left direction, and raising a left arm.

If the output unit 122 performs the operation according to the input of the manipulation command, the sensor unit 111 recognizes the physical operation of the device or system to output the sensing information related to the physical operation. That is, the sensor unit 111 can measure variations in mode of 3-5-12-7-1-0 by detecting the intensity of illumination, measure variations in volume of 30-25-20-15-5-0 by detecting the sound pressure, measure variations in temperature of 18-20-24-26 degrees by detecting the temperature, or measure the motion of the robot by the encoding sensor.

If the sensor unit 111 outputs the sensing information, the converter 115 converts the sensing information into the control signal (S220), and the micom 116 stores the history of the sensing information converted by the converter 115 in the memory 118 (S225).

The history of the sensing information stored in the memory 118 can be accumulated for a desired time, if one storage command is first inputted from the storage command input unit 112. Alternatively, the history of the sensing information stored in the memory 118 may be accumulated until an end command is inputted from the storage command input unit 112.

After that, if the user inputs the replay command by the replay command input unit 113 (S230), the micom 116 outputs the control signal corresponding to the history of the sensing information stored in the memory 118 (S235). The outputted control signal can be directly transmitted to the output unit 122 of the replay module 120 to cause the device of interest to operate, or be transmitted to an external device through the connector 117 to cause the external device to operate.

If the output unit 122 of the replay module 120 receives the control signal to be replayed from the micom 116, the output unit 122 replays the operation which has been previously performed, according to the input control signal (S240). For example, the intensity of illumination of the illuminating device can be sequentially changed in the mode of 3-5-12-7-1-0, the volume of the audio device can be sequentially changed in the mode of 30-25-20-15-5-0, the operating temperature of the air conditioner can be sequentially adjusted in the mode of 18-20-24-26 degrees, or the toy robot can be operated in the process of moving forward 10 cm, left turning, reversing 20 cm, turning a head in a left direction, and raising a left arm by operating the drive motor of the toy robot.

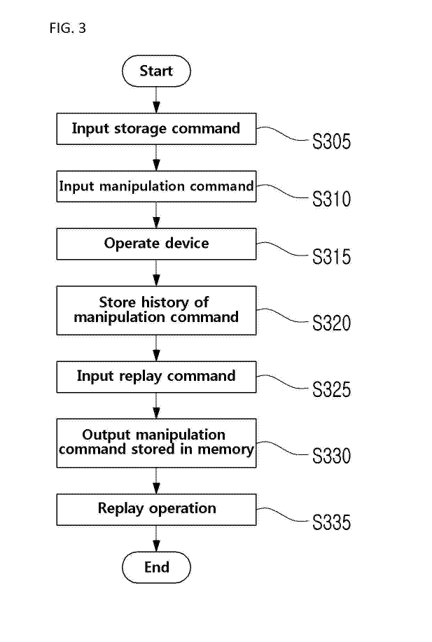

FIG. 3 shows the process of storing and replaying the history of the manipulation command, if the storage command of the user is inputted by the operation replay module in FIG. 1.

First, the user inputs the storage command by the storage command input unit 112 to store the process to be replay later (S305). That is, it signals the start of the storage.

Then, if the user inputs the manipulation command by the manipulation command input unit 121 (S310), the output unit 122 of the replay module 120 operates the device or system according to the manipulation command (S315).

At the same time, the micom 116 of the storage module 110 stores the history of the manipulation command inputted from the manipulation command input unit 121 in the memory 118 (S320). A display command which should be displayed on a display device, such as seven segments, mounted on an education block, for example, a manipulation command of 5-4-3-2-1, is inputted, numerals of 5-4-3-2-1 are sequentially displayed on the display device, and the history of the manipulation command is stored in the memory 118.

The history of the manipulation command stored in the memory 118 can be accumulated for a desired time, if one storage command is first inputted from the storage command input unit 112. Alternatively, the history of the manipulation command stored in the memory 118 may be accumulated until an end command is inputted from the storage command input unit 112. In addition, in case where the manipulation command is not inputted for a predetermined time, the storage process can be automatically ended.

After that, if the user inputs the replay command by the replay command input unit 113 (S325), the micom 116 outputs the control signal corresponding to the history of the manipulation command stored in the memory 118 (S330), so that the stored operation replays (S335). The outputted control signal can be directly transmitted to the output unit 122 of the replay module 120 to cause the device of interest to operate, or be transmitted to an external device through the connector 117 to cause the external device to operate.

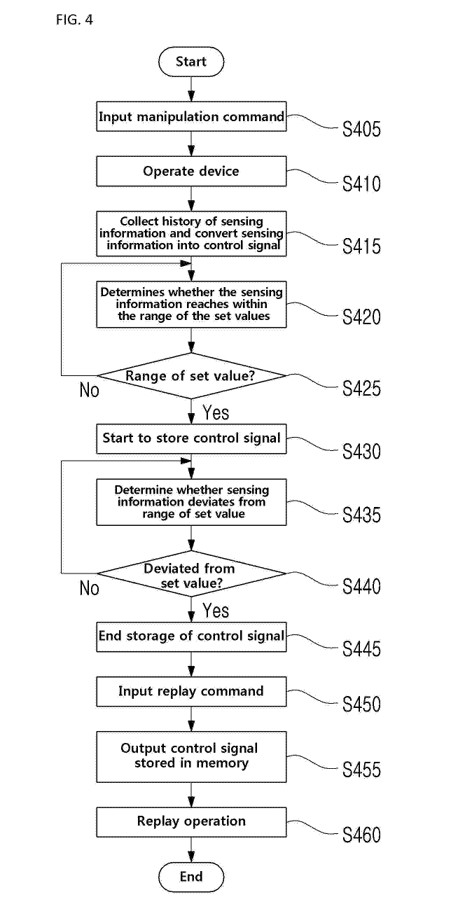

FIG. 4 shows the process of automatically storing and replaying the history of the sensing information according to the range of the set value previously stored, even though any storage command is not inputted from the operation replay module in FIG. 1.

First, the user directly inputs the manipulation command (S405), without inputting the storage command by the storage command input unit 112, and the output unit 122 of the replay module 120 operates the device or system according to the input of the manipulation command (S410).

The sensor unit 111 recognizes the physical operation of the device or system to output the sensing information. If the sensor unit 111 outputs the sensing information, the converter 115 converts the sensing information into the control signal (S415), and the micom 116 determines whether the sensing information converted by the converter 115 reaches within the range of the set values previously stored in the memory 118 (S420).

For example, the micom 116 determines whether the intensity of illumination of the illuminating device reaches 5, determines whether an indoor temperature reaches 26 degrees by the operation of the air conditioning system, or determines whether the toy robot moves forward by 5 cm or more.

If it is determined that the sensing information reaches within the range of the set value previously stored in the memory 118 (S425), the micom 116 controls to store the sensing information measured by the sensor unit 111 in the memory 118. More specifically, if the sensing information is converted into the control signal by the converter 115, the micom 116 starts to store it in the memory 118 (S430).

After that, the micom 116 compares the sensing information with the range of set values to determine whether the sensing information deviates from the range of set values (S435). For example, the micom 116 determines whether the intensity of illumination of the illuminating device exceeds 15, determines whether the indoor temperature goes down below 18 degrees by the operation of the air conditioning system, or determines whether the toy robot reverses by 10 cm or more.

If the micom 116 determines that the sensing information deviates from the range of set values (S440), the micom 116 ends the process of storing the control signal converted by the converter (S445). That is, even though the sensing information is measured by the sensing unit, no history of the sensing information is further stored.

After that, if the user inputs the replay command by the replay command input unit 113 (S450), the micom 116 outputs the control signal corresponding to the history of the sensing information stored in the memory 118 (S460). The outputted control signal can be directly transmitted to the output unit 122 of the replay module 120 to cause the device of interest to operate, or be transmitted to an external device through the connector 117 to cause the external device to operate.

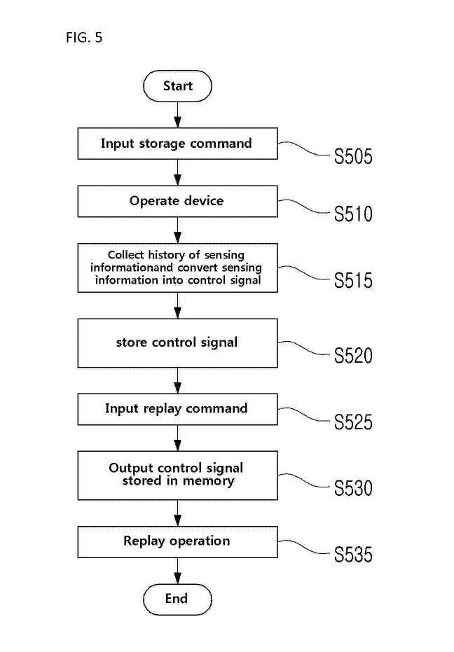

FIG. 5 shows the process of storing and replaying the history of the sensing information, if the user operates the device by the operation replay module in FIG. 1, without inputting any manipulation command.

First, the user inputs the storage command by the storage command input unit 112 to store the process to be replay later (S505). That is, it signals the start of the storage.

Then, the user applies an external force to the device to operate the device (S510). That is, in case of the toy robot which is assembled by blocks, the toy robot may be operated by programing previously stored or the manipulation command inputted by the user, but if each joint of the toy robot or the drive motor is equipped with an encoder sensor, it is possible to collect the sensing information by the encoder sensor even when the toy robot is operated by the external force applied by the user. For example, if the user raises his or her right arm and then lowers the right arm, the sensing information related to the joint motion can be collected by the sensor unit 111 (encoder sensor) of the drive motor mounted to each joint of the right arm, when the user raises and lowers the right arm. If the toy robot is pushed to move forward by 30 cm, the sensing information related to the forward motion of 30 cm can be collected by the sensor unit 111 (encoder sensor) of the drive motor interlocked to a wheel.

If the sensor unit 111 recognizes the physical motion of the device to output the sensing information (physical value) corresponding to the physical motion when the device is moved by application of the external force from the user, the converter 115 converts the sensing information into the control signal (S515), and the micom 116 stores the control signal corresponding to the history of the sensing information converted by the converter 115 in the memory 118 (S520).

The history of the sensing information stored in the memory 118 can be accumulated for a desired time, if one storage command is first inputted from the storage command input unit 112. Alternatively, the history of the sensing information stored in the memory 118 may be accumulated until an end command is inputted from the storage command input unit 112. Also, the history of the sensing information may be accumulated until no more sensing information is outputted from the sensor unit 111, since the external force is not applied.

After that, if the user inputs the replay command by the replay command input unit 113 (S525), the micom 116 outputs the control signal corresponding to the history of the sensing information stored in the memory 118 (S530). The outputted control signal can be directly transmitted to the output unit 122 of the replay module 120 to cause the device of interest to operate, or be transmitted to an external device through the connector 117 to cause the external device to operate.

If the output unit 122 of the replay module 120 receives the control signal to be replayed from the micom 116, the output unit 122 replays the operation which has been previously performed, according to the input control signal (S535). For example, the toy robot repeats the motion, in which the toy robot is moved by application of the external force to the robot from the user, by operating the drive motor of the toy robot.

As described above, even though the user has no specialized knowledge of programing, the user can replay the same operation on the device or system, without re-inputting the manipulation command, if the user intentionally manipulates the device or system and inputs the replay command. Therefore, the present invention can improve user convenience in the field of toy robot or office automation.

The present invention can be applied to the fields of industrial robot, domestic robot, home automation and building automation, in addition to the illuminating device, the audio device, the air conditioning system, and the toy robot which have been described hereinbefore.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. An operation replay module comprising:
a manipulation command input unit that receives a manipulation command from a user;
an output unit that outputs a control signal corresponding to the manipulation command from the manipulation command input unit;
a memory that stores history of the manipulation command;
a replay command input unit that receives a replay command from the user; and
a micom that outputs a control signal corresponding to the history of the manipulation command stored in the memory to the output unit, if the micom receives the replay command from the replay command input unit.

2. An operation replay module comprising:
a sensor unit that measures a physical value generated by physical operation to output sensing information;
a converter that converts history of the sensing information into a control signal;
a memory that stores the control signal converted by the converter;
a replay command input unit that receives a replay command from the user; and
a micom that outputs a control signal corresponding to history of the sensing information stored in the memory to an output unit, if the micom receives the replay command from the replay command input unit.

3. The operation replay module according to claim 2, further comprising:
a manipulation command input unit that receives a manipulation command from the user; and
an output unit that outputs a control signal corresponding to the manipulation command from the manipulation command input unit,
wherein the sensor unit measures a physical value of a device which is operated by the control signal outputted from the output unit to output sensing information.

4. The operation replay module according to claim 2, wherein a range of set values is previously stored in the memory, and if the micom determines that the sensing information measured by the sensor unit reaches within the range of the set values stored in the memory, the micom stores the control signal related to the history of the sensing information in the memory.

5. The operation replay module according to claim 1, further comprising a storage command input unit that receives a storage command from the user,
wherein if the micom receives the storage command from the storage command input unit, the micom stores the history of the manipulation command or the control signal related to the history of the sensing information in the memory.

6. The operation replay module according to claim 2, further comprising a storage command input unit that receives a storage command from the user,
wherein if the micom receives the storage command from the storage command input unit, the micom stores the history of the manipulation command or the control signal related to the history of the sensing information in the memory.
